(19) United States
(12) Patent Application Publication
(10) Pub. No.: US 2005/0278450 A1
(43) Pub. Date: Dec. 15, 2005

(54) Wireless proximity area network connectivity platform

(76) Inventors: Michel Pelletier, Beaconsfield (CA); Jerome Pesant, St-Hubert (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/856,766

(22) Filed: Jun. 1, 2004

(51) Int. Cl. G06F 3/00

(52) U.S. Cl. 709/229

(57) ABSTRACT

A method and an apparatus are disclosed for optimizing the use of a plurality of peripheral devices (e.g., keyboard, mouse, display unit, printer, etc.) with the computing capabilities of a portable processing device (e.g., PDA, handheld computer, portable computer, smart phone, PC tablet, etc.). Specific functions include using wireless technologies, such as Bluetooth, Wi-Fi, etc., for communicating between a connectivity platform and the portable processing device, rerouting of data signals from the portable processing device's existing peripherals to corresponding external peripheral devices, and providing contact-less energy replenishment capabilities.

### TECHNICAL FIELD

This invention relates to the field of communications. More precisely, this invention pertains to the field of wireless proximity area networks (e.g., local area networks, personal area networks, and body area networks).

### BACKGROUND OF THE INVENTION

Personal digital assistants, personal computers, portable computers, PC tablets and smart phones are amongst mobile and portable processing devices for which computing and processing performance is increasing. Such processing devices enable their users to use them in a wide variety of locations.

In fact, the foregoing devices are capable of communicating with similar devices as well as with peripheral devices using technologies such as IEEE 802.11 (Wi-Fi), IEEE 802.15, Bluetooth, ZigBee, etc. However, it has been contemplated that such communication is not efficient in many cases. For instance, such communication causes extra power consumption in that additional power is required to communicate and to power up the peripheral device. Also, many peripheral devices require a dedicated power outlet, which is not really convenient, especially in an environment where a limited number of power outlets is available, as in a car for instance.

Moreover, in the case where a given processing device has a limited number of communication interfaces, it is impossible to use a desired peripheral device which has a communication interface that is incompatible with the communication interface located in the given processing device.

There is therefore a need for a method and apparatus that will overcome the above-identified drawbacks.

### SUMMARY OF THE INVENTION

It is an object of the invention to provide a method for optimizing a use of a plurality of peripheral devices with a processing device.

Yet another object of the invention is to provide an apparatus for optimizing a use of a plurality of peripheral devices with a processing device.

According to an embodiment, the present invention provides a method for allowing communication between a peripheral device and a portable processing device. The peripheral device is capable of communicating with a connectivity platform. The connectivity platform and portable processing device are capable of wireless communication. The method comprises determining that the portable processing device is within wireless communication range of the connectivity platform; establishing wireless communication between the portable processing device and the connectivity platform; launching an application on the portable processing device, the application being indicative of accessibility of the peripheral device; and allowing communication between the peripheral device and the portable processing device using the application.

According to another embodiment, the present invention provides a connectivity platform for allowing communication between a peripheral device and a portable processing device. The peripheral device is capable of communicating with a connectivity platform and the-portable processing device is capable of wireless communication. The connectivity platform comprises a wireless communication port for detecting the presence of the portable processing device within wireless communication range of the connectivity platform and for establishing wireless communication between the portable processing device and the connectivity platform. The connectivity platform further comprises a processing unit for sending a message to the portable processing device indicative of accessibility of the peripheral device and for allowing communication between the peripheral device and the portable processing device upon receipt of a confirmation message from the portable processing device.

According to an aspect of the invention, there is provided a method for optimizing a use of a processing device, the method comprising detecting a peripheral device connected to a connectivity platform, detecting an existing peripheral device used by the processing device, detecting the processing device wirelessly capable of communicating with the connectivity platform according to a wireless protocol and providing an alternate data path for replacing the existing peripheral device with the peripheral device connected to the connectivity platform, wherein the processing device is capable of using the peripheral device connected to the connectivity platform thereby optimizing its use.

According to another aspect of the invention, there is provided a connectivity platform for optimizing a use of a plurality of peripheral devices with a processing device to which is connected a plurality of existing peripheral devices, the connectivity platform comprising a communication port for communicating with the plurality of peripheral devices and further with the processing device, a memory unit storing an indication of the plurality of peripheral devices and the plurality of existing peripheral devices, a processing unit operatively coupled to the communication port and the memory unit, the processing unit receiving a data signal provided by the processing device via the communication port and providing at least one part of the data signal to a peripheral device corresponding to a given existing peripheral device via the communication port, the processing unit further providing a disabling signal to the processing device for disabling the given existing peripheral device.

### BRIEF DESCRIPTION OF THE DRAWINGS

Further features and advantages of the present invention will become apparent from the following detailed description, taken in combination with the appended drawings, in which:

FIG. 1 is a block diagram which shows a system having a connectivity platform in accordance with an embodiment of the invention;

FIG. 2 is a block diagram which shows, inter alia, the connectivity platform in accordance with a preferred embodiment;

FIG. 3 is a flowchart which shows how the connectivity platform is used in a preferred embodiment; a processing device is detected with existing peripheral devices, at least one peripheral device is detected, a rerouting of data is selected and the selected rerouting of data is performed;

FIG. 4 is a flowchart which shows how the processing device is detected with existing peripheral devices according to a preferred embodiment;

FIG. 5 is a flowchart which shows how the plurality of peripheral devices is detected according to a preferred embodiment;

FIG. 6 is a flowchart which shows how the selection of a rerouting of data is performed in a preferred embodiment;

FIG. 7 is a flowchart which shows how the selected rerouting of data is performed in a preferred embodiment;

FIG. 8 is a schematic showing a connectivity platform, according to a preferred embodiment of the invention, and the components with which it may communicate; and

FIG. 9 is a schematic showing a connectivity platform, according to a second preferred embodiment of the invention, and the components with which it may communicate.

It will be noted that throughout the appended drawings, like features are identified by like reference numerals.

### DETAILED DESCRIPTION OF THE INVENTION

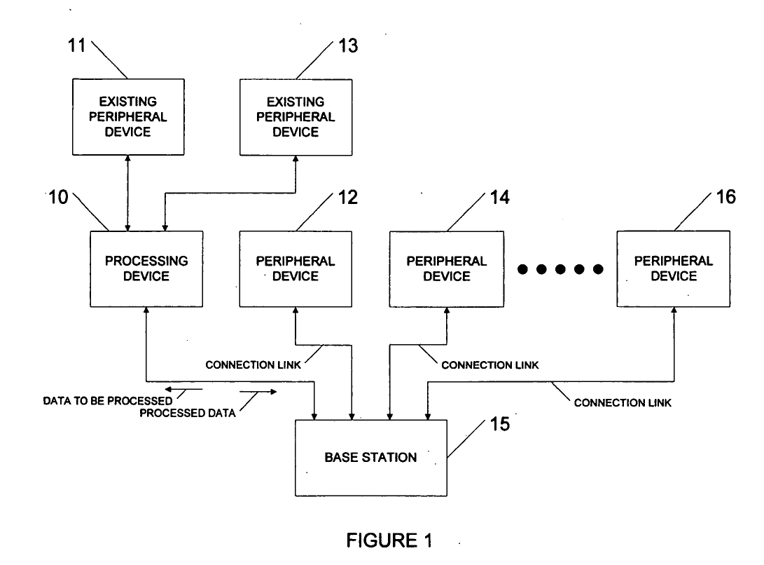

Now referring to FIG. 1, there is shown a system where connectivity platform 15 is used in accordance with the invention. In this embodiment, the system comprises connectivity platform 15, a processing device 10 connected to a first existing peripheral device 11 and to a second existing peripheral device 13. The system further comprises a first peripheral device 12, a second peripheral device 14 and another peripheral device 16.

Processing device 10 may be any one of a portable mobile computer, a personal digital assistant (PDA), a hand held computing device or the like. In fact, processing device 10 comprises at least one processor.

In the system disclosed in FIG. 1, processing device 10 is connected to first existing peripheral device 11 and to second existing peripheral device 13. First existing peripheral device 11 and second existing peripheral device 13 may be any one of an internal peripheral device such as a soundcard or an external peripheral device such as a display screen, a printer or the like.

In fact, it should be understood that while it has been disclosed that first existing peripheral device 11 and second existing peripheral device 13 are connected to processing device 10, those skilled in the art should appreciate that first existing peripheral device 11 and second existing peripheral device 13 may be part of processing device 10.

Generally, peripheral devices are meant to include at least input/output peripheral devices such as those listed below. First peripheral device 12, second peripheral device 14 and peripheral device 16 may be selected, for example, from a group consisting of at least a mouse, a keyboard, a printer, a screen display, a Hi-Fi headphone, a microphone; an ambient speaker, a digital camera, a digital camcorder, a haptic or non haptic steering wheel device, an accelerator/break pedal apparatus, a game controller, a mobile communication device, a trackball, a universal remote mobile controller, a set-top box, an image/video capture unit or a wireless pointer.

In fact, it should be understood by the person skilled in the art that first peripheral device 12, second peripheral device 14 and peripheral device 16 are selected more generally from a group comprising any wireless or wired communication enabled and capable devices.

Connectivity platform 15 receives processed data from processing device 10 and provides at least one part of the processed data to at least one of first peripheral device 12, second peripheral device 14 and peripheral device 16. Connectivity platform 15 provides a data signal to be processed by processing device 10.

A plurality of connection links are created between connectivity platform 15 and at least one of first peripheral device 12, second peripheral device 14 and peripheral device 16. It will be appreciated that a connection link between connectivity platform 15 and a peripheral device is used to provide at least one of a data signal and a power signal as explained below.

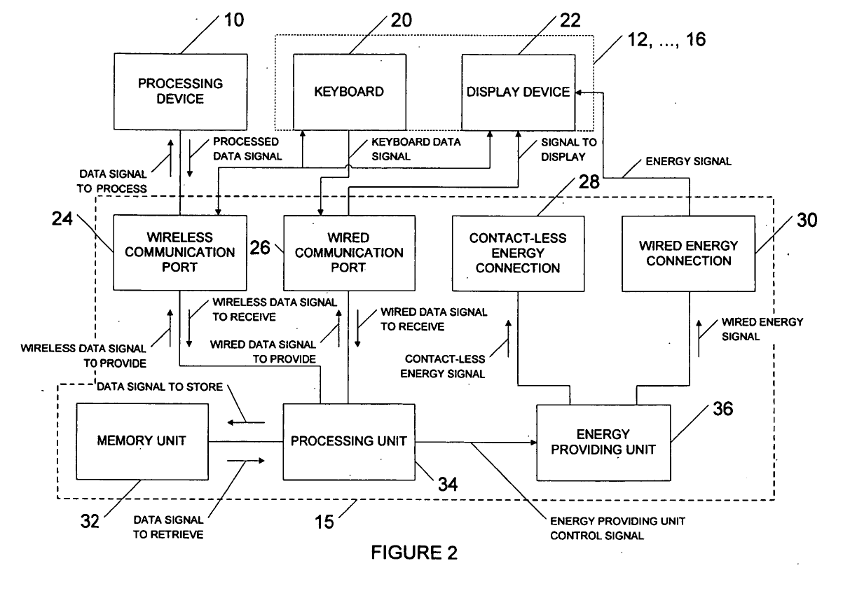

Now referring to FIG. 2, there is shown a preferred embodiment of connectivity platform 15. Connectivity platform 15 comprises a wireless communication port 24, a wired communication port 26, a contact-less energy connection 28, a wired energy connection 30, a memory unit 32, a processing unit 34 and an energy providing unit 36.

Wireless communication port 24 is used to communicate with at least one of processing device 10, first peripheral device 12, second peripheral device 14 and peripheral device 16. More precisely, wireless communication port 24 receives/provides a wireless data signal from at least one of processing device 10, first peripheral device 12, second peripheral device 14 and peripheral device 16. Wireless communication port 24 further receives a wireless data signal which is provided by processing unit 34. Wireless communication port 24 provides to processing unit 34 a received wireless data signal. It is also contemplated to provide wireless communications ports 24 of various types.

In the embodiment disclosed in FIG. 2, wireless communication port 24 is used to communicate with processing device 10. It will be appreciated that wireless communication port 24 may be used to communicate with any wireless communication interface. Wireless communication port 24 may therefore be adapted to communicate according to at least one of the following standards: IEEE 802.11 (Wi-Fi), IEEE 802.15, Bluetooth, Zigbee, Ultra Wideband (UWB), or the like.

A person skilled in the art will understand that the selection of wireless communication port 24 is dependent at least on the power consumption and on the data transfer rate.

Wired communication port 26 is used to communicate with at least one of processing device 10, first peripheral device 12, second peripheral device 14 and peripheral device 16. Wired communication port 26 provides/receives a wired data signal to/from at least one of processing device 10, first peripheral device 12, second peripheral device 14 and peripheral device 16. Wired communication port 26 further receives a wired data signal to provide from processing unit 34 and further provides a received wired data signal to processing unit 34.

In the embodiment disclosed in FIG. 2, wired communication port 26 is used to communicate with a keyboard 20. It will be appreciated that wired communication port 26 may be used to communicate with any wired communication interface. Wired communication port 26 may therefore be any one of at least a serial port (RS232), a parallel port, an RGB port, a Universal Serial Bus (USB), a PS/2 port, an IEEE 1394 port (Firewire), an SNideo port or the like. In the embodiment disclosed in FIG. 2, wired communication port 26 provides a signal to display to a display device 22.

Contact-less energy connection port 28 is used to provide a contact-less power signal to at least one of processing device 10, first peripheral device 12, second peripheral device 14 and peripheral device 16, shown in FIG. 1 but for clarity purposes not in FIG. 2. Contact-less energy connection port 28 receives a contact-less energy signal to provide power from energy providing unit 36 and provides a contact-less signal to at least one of processing device 10, first peripheral device 12, second peripheral device 14 and peripheral device 16.

In a preferred embodiment, contact-less energy connection port 28 operates according to contact-less power transfer apparatus disclosed in published U.S. patent application N^{o}2003/0210106 and entitled “Contact-less power transfer”, the specification of which is hereby incorporated by reference.

Wired energy connection 30 is used to provide power to at least one of processing device 10, first peripheral device 12, second peripheral device 14 and peripheral device 16. More precisely, wired energy connection 30 receives a wired energy signal to provide from energy providing unit 36 and provides an energy signal to at least one of processing device 10, first peripheral device 12, second peripheral device 14 and peripheral device 16.

Wired energy connection 30 provides the energy signal in accordance with a desired specification. Those skilled in the art will therefore appreciate that the energy signal may be at least one of an AC and/or a DC power source and may further have electrical characteristics compatible with a device to which power is fed. It is also understood that wired energy connection 30 provides power bar and power surge management capabilities. In the embodiment disclosed in FIG. 2, wired energy connection 30 provides an energy signal to display device 22.

Still referring to FIG. 2, the connectivity platform comprises processing unit 34. Processing unit 34 in turn comprises a processor (not shown). Connectivity platform 15 further comprises memory unit 32. Memory unit 32 is used to store data for the operation of connectivity platform 15. Memory unit 32 receives a data signal to store from processing unit 34 and provides a data signal to retrieve to processing unit 34.

Still in the embodiment disclosed in FIG. 2, connectivity platform 15 comprises energy providing unit 36. Energy providing unit 36 is adapted to provide a contact-less energy signal to contact-less energy connection 28. More precisely, energy providing unit 36 provides contact-less energy signal to contact-less energy connection 28 and further provides to wired energy connection 30 wired energy signal to provide. Energy providing unit 36 is preferably controlled by processing unit 34 using an energy providing unit control signal.

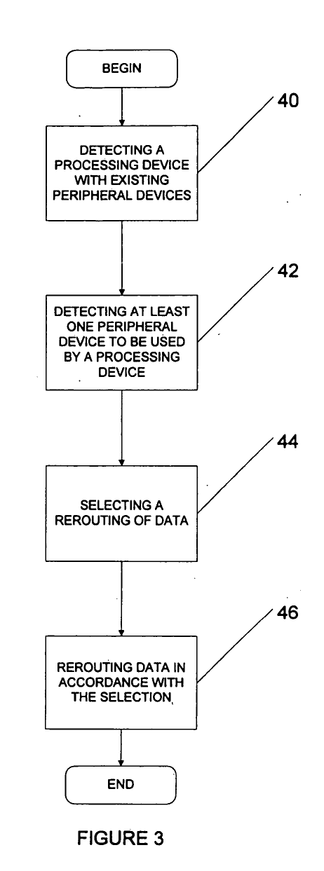

Now referring to FIG. 3, there is shown how connectivity platform 15 operates according to an embodiment of the invention. According to step 40, a processing device with existing peripheral devices is detected. In a preferred embodiment, the detection is performed by connectivity platform 15. According to step 42, at least one peripheral device to be used with the detected processing device is detected. In a preferred embodiment, the detection is performed by connectivity platform 15. Alternatively, it could be performed by other means external to the connectivity platform known to those skilled in the art and a detection status signal could then be provided to the connectivity platform.

According to step 44, a selection of a rerouting of data is performed. In a preferred embodiment, the selection is performed using processing device 10 as explained herein. According to step 46, a rerouting of data is performed. In a preferred embodiment, the rerouting of data is performed in accordance with the selection performed at step 44.

Now returning to FIG. 2, according to an embodiment, the method of the present invention enables communication between peripheral devices 12 to 16 and portable processing device 10. Peripheral devices 12 to 16 are capable of communicating With connectivity platform 15. Connectivity platform 15 and portable processing devices 12 to 16 are capable of wireless communication. The method includes a step of determining that portable processing device 10 is within wireless communication range of connectivity platform 15. Wireless communication between portable processing device 10 and connectivity platform 15 is then established. The next step is to launch an application on portable processing device 10. The application is indicative of accessibility of peripheral devices 12 to 16. Finally, the method enables communication between peripheral devices 12 to 16 and portable processing device 10 using the application.

In a preferred embodiment, the application provides a list of the accessible peripheral device 12 to 16. The method may also further include selecting at least one of peripheral devices 12 to 16 from the list thereby allowing use of the selected peripheral device by portable processing device 10.

According to an embodiment, connectivity platform 15 enables communication between peripheral devices 12 to 16 and portable processing device 10. Peripheral devices 12 to 16 are capable of communicating with connectivity platform 15 and portable processing device 10 is capable of wireless communication. Connectivity platform 15 comprises wireless communication port 24 for detecting the presence of portable processing device 10 within wireless communication range of connectivity platform 15. Connectivity platform 15 is also capable of establishing a wireless communication between portable processing device 10 and connectivity platform 15. Connectivity platform 15 further comprises processing unit 34 for sending a message to portable processing device 10 indicative of accessibility of peripheral devices 12 to 16. The message from connectivity platform 15 is also for allowing communication between peripheral devices 12 to 16 and portable processing device 10 upon receipt of a confirmation message from portable processing device 10.

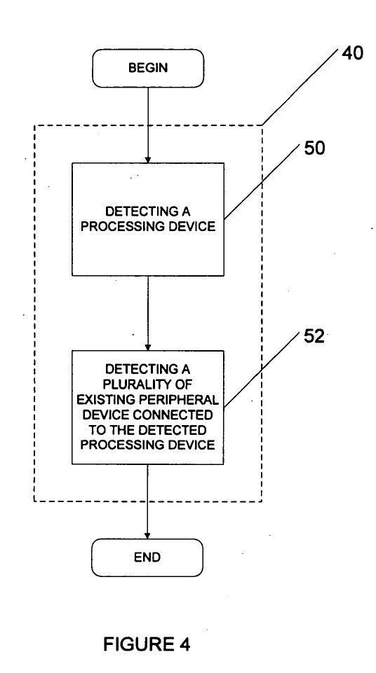

Now referring to FIG. 4, there is shown the detection of processing device 10 with its existing peripheral devices. According to step 50, processing device 10 is detected. Now referring back to FIG. 2, processing device 10 may be detected using at least one of wireless communication port 24 and the wired communication port.

Connectivity platform 15 is compatible with a predetermined set of processing devices. In a preferred embodiment, processing device 10 is detected using a polling scheme via the wireless port or the wired port.

Referring to FIG. 4 and according to step 52, a plurality of existing peripheral devices connected to detected processing device 10 is detected. It will be appreciated that the plurality of existing peripheral devices connected to detected processing device 10 may be detected using various strategies.

For instance, in one embodiment, a user of processing device 10 may disclose via processing device 10 a list indicative of the plurality of existing peripheral devices connected to detected processing device 10. In fact, in a preferred embodiment, a user-based profile determines the list of peripherals. It is also contemplated that the profile may be manually overridden.

Alternatively, the step of detecting a plurality of existing peripheral devices connected to detected processing device 10 may comprise providing to processing unit 34 of connectivity platform 15, a configuration file of processing device 10. The configuration file being indicative of the plurality of existing peripheral devices which are connected to detected processing device 10.

In fact it will be appreciated that, preferably, a driver is provided to processing device 10 upon its detection. Such providing enables the provision of the configuration file of processing device 10 to connectivity platform 15.

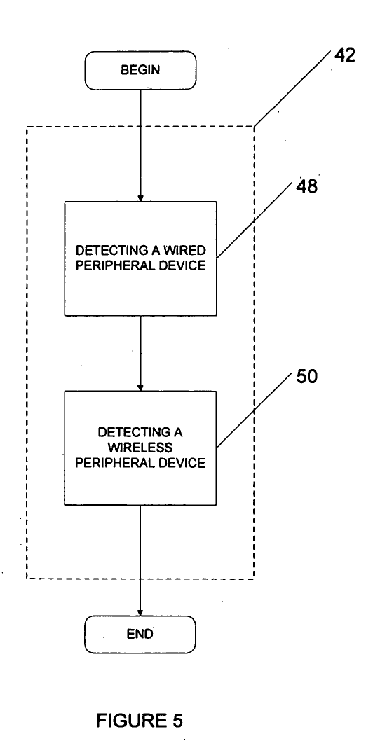

Now referring to FIG. 5, there is shown how at least one peripheral device to be used with a detected processing device is detected. According to step 48, a wired peripheral device is detected.

Now referring back to FIG. 2, it will be appreciated that the wired peripheral device is detected using wired communication port 26.

Referring to FIG. 5 and according to step 50, a wireless peripheral device is detected. It will be appreciated that wireless peripheral device is detected using wireless communication port 24. Upon detection of at least one peripheral device to be used by processing device 10, an indication of such detection is stored preferably in memory unit 32.

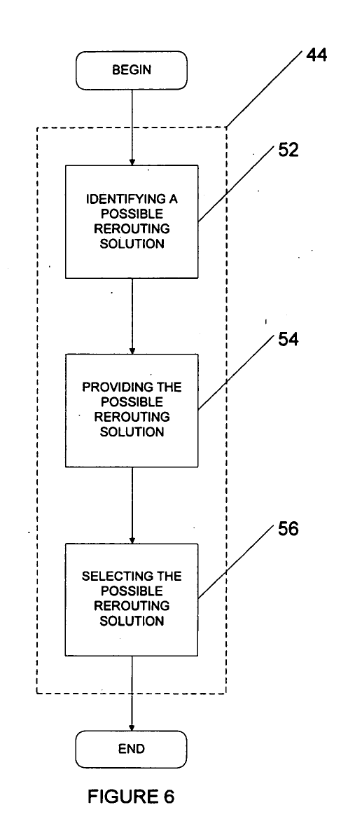

Now referring to FIG. 6, there is shown how a selection of a rerouting of data is performed. More precisely, according to step 52, at least one possible rerouting solution is detected. It will be appreciated by the person skilled in the art that for instance, as shown in FIG. 2, the detected peripheral device may comprise display device 22. It may be further appreciated that processing device 10 is already connected to an existing peripheral device which is also a display device. Accordingly, it may be of great advantage to use display device 22 rather than to use the existing peripheral display device. In such case, there may exist a possible rerouting solution of data from the existing display device to display device 22.

It will be appreciated that a plurality of rerouting solutions may be identified depending on the detected existing peripheral devices of processing device 10 and the detected peripheral devices.

In one embodiment the plurality of rerouting solutions is automatically identified by processing unit 34 of connectivity platform 15, while in another embodiment, the plurality of rerouting solutions are identified manually by the user via processing device 10.

According to step 54, an indication of at least one identified rerouting solution identified according to step 52 is provided to the user of processing device 10. It will be appreciated that the indication of at least one identified rerouting solution may be provided to the user of processing device 10 according to various schemes. For instance, the indication of at least one identified rerouting solution may be provided for an existing peripheral device.

According to step 56, at least one rerouting solution is selected. In one embodiment, the selection is performed automatically using a configuration file. Alternatively, the user of processing device 10 may select manually, via processing device 10, at least one rerouting solution using the indication of at least one identified rerouting solution. It will be appreciated that preferably an indication of the selection of at least one possible rerouting solution is stored in the memory unit 32 of connectivity platform 15.

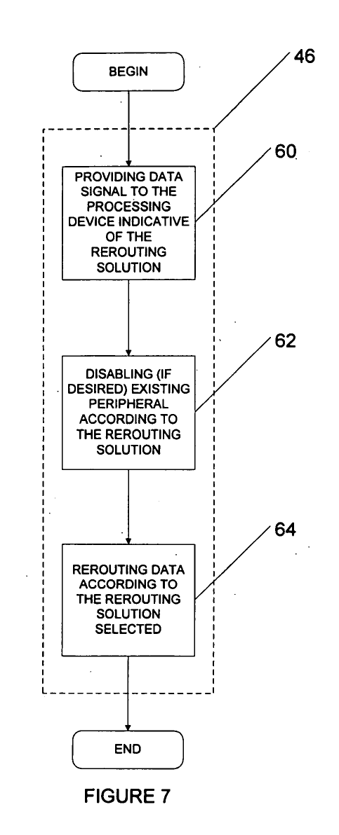

Now referring to FIG. 7, there is shown how the rerouting of data is performed. According to step 60, a data signal indicative of at least one rerouting solution selected to implement is provided to processing device 10.

According to step 62, at least one existing peripheral device is disabled according to the data signal indicative of at least one rerouting solution selected to implement. In some instances, disabling of a peripheral may not be desired by the user. It is therefore also contemplated to reroute or, in some cases, reestablish the signal to a peripheral device while keeping the existing peripheral in operation. That is, the existing peripheral may still be used if the user so desires.

In a preferred embodiment, the disabling is performed by processing device 10. It will be appreciated that such disabling may, in many cases, imply a reduction of power consumption which is of great advantage. Still in a preferred embodiment, the disabling will be performed depending on the existing peripheral device and on how the existing peripheral device is connected to processing device 10. According to step 64, the data signal is rerouted according to at least one selected rerouting solution. The rerouting of the data signal is performed via connectivity platform 15.

Now referring back to FIG. 2, it should be understood that connectivity platform 15 further provides an energy signal to the plurality of peripheral devices depending on at least which of the plurality of peripheral devices is used. The energy signal may be provided using at least one of contact-less energy connection 28 and the wired energy connection.

The person skilled in the art will therefore appreciate that connectivity platform 15 provides to the user of processing device 10 a great connectivity tool. Such connectivity platform 15 is preferably used for accommodating a single processing device 10. Alternatively, connectivity platform 15 may be used with more than one processing device 10.

Connectivity platform 15 may be used for instance by the traveler in a hotel room or airport business lounge where many peripheral devices may be located in the vicinity of processing device 10. Other applications include small offices, homes, aircraft, trains, watercraft, conference rooms, health care institutions, etc. Numerous other examples would be equally possible. In such cases, the processing device may be a PDA, and peripheral devices may comprise an LCD screen, a mobile phone, or the like. It has been contemplated that connectivity platform 15 is of great advantage when communication is performed via wireless communication port 24. One such advantage is apparent when the user is equipped with connectivity platforms located at both office and home thereby enabling an extremely portable and fully functional environment.

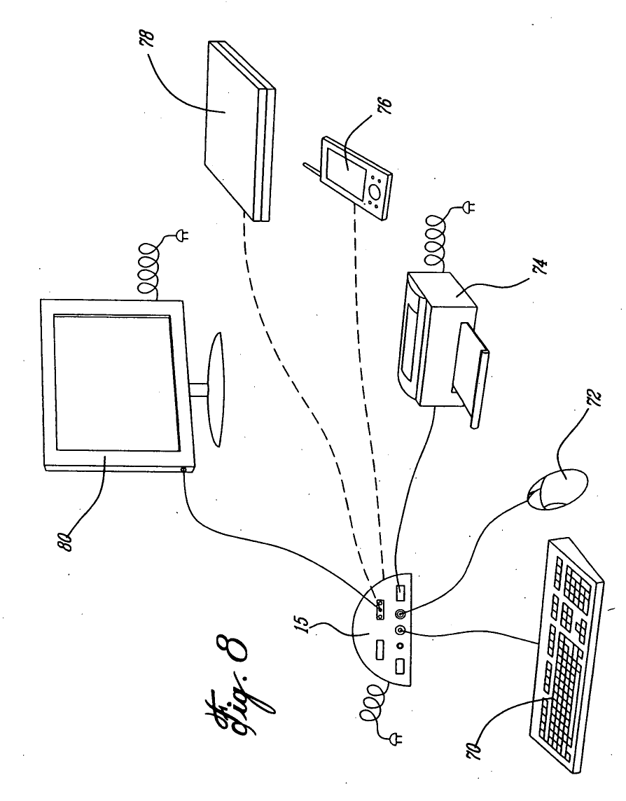

Now turning to FIG. 8, a schematic diagram shows a connectivity platform 15 according to a preferred embodiment of the invention. In this embodiment, PDA 76 and laptop computer 78 are wirelessly connected (dashed lines) to connectivity platform 15. Connectivity platform 15 is shown connected to commonly used peripheral devices such as display 80, printer 74, mouse 72 and keyboard 70. In FIG. 8, the connections to the peripherals are shown as hardwire connections. However, the peripherals could also be wirelessly connected to connectivity platform 15.

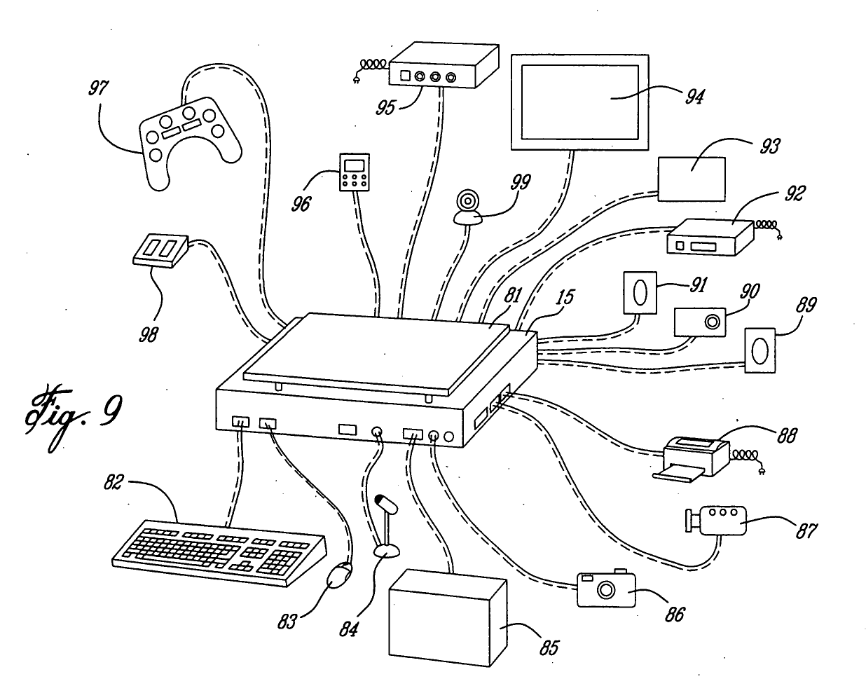

Now referring to FIG. 9, a schematic diagram shows connectivity platform 15, according to a second preferred embodiment of the invention. In this particular embodiment, a contact-less energy connection 81 is mounted on connectivity platform 15. Contact-less energy connection 81 is used to provide a contact-less power signal to any of the components shown on FIG. 9 which are adapted to receive power from such a source (e.g., PDA 76). In the second preferred embodiment, portable processing device 96 (e.g., PDA, smart phone, laptop, handheld computer, PC tablet, etc.) and desktop computer 85 are connected (wirelessly or hardwired) to connectivity platform 15. Connectivity platform 15 may also be connected to (wirelessly or hardwired) peripherals such as keypad 82, mouse 83, microphone 84, digital camera 86, video camera 87, printer 88, speakers 89, 90, 91, display 94, webcam 99, gaming controls 97, 98, set top box 95, multimedia player and recorder 92, or any other devices 93 such as appliances, light switches, security systems, remote mobile controllers, Hi-Fi stereo headsets, haptic/non-haptic steering wheels, track balls, pen, etc.

The embodiments of the invention described above are intended to be exemplary only. The scope of the invention is therefore intended to be limited solely by the scope of the appended claims.

1. A method for allowing communication between a peripheral device and a portable processing device, the peripheral device being capable of communicating with a connectivity platform, the connectivity platform and portable processing device being capable of wireless communication, the method comprising:
determining that the portable processing device is within wireless communication range of the connectivity platform;
establishing wireless communication between the portable processing device and the connectivity platform;
launching an application on the portable processing device, the application being indicative of accessibility of the peripheral device; and
allowing communication between the peripheral device and the portable processing device using the application.

2. The method as claimed in claim 1, further comprising providing an energy signal to the peripheral device.

3. The method as claimed in claim 2, wherein the step of providing an energy signal comprises at least one of providing a contact-less energy signal and providing a hardwired energy signal to the peripheral device.

4. The method as claimed in claim 1, wherein the peripheral device comprises a plurality of peripheral devices and further wherein the application provides a list comprising more than one accessible peripheral device.

5. The method as claimed in claim 4, further selecting at least one of the peripheral devices from the list thereby allowing use of the selected peripheral device by the portable processing device.

6. A connectivity platform for allowing communication between a peripheral device and a portable processing device, the peripheral device being capable of communicating with a connectivity platform, the portable processing device being capable of wireless communication, the connectivity platform comprising:
a wireless communication port for detecting the presence of the portable processing device within wireless communication range of the connectivity platform and for establishing wireless communication between the portable processing device and the connectivity platform;
a processing unit for sending a message to the portable processing device indicative of accessibility of the peripheral device and for allowing communication between the peripheral device and the portable processing device upon receipt of a confirmation message from the portable processing device.

7. The connectivity platform as claimed in claim 6, further comprising an energy connection port, controlled by the processing unit, for providing an energy signal to the peripheral devices.

8. The connectivity platform as claimed in claim 7, wherein the energy connection port comprises at least one of a contact-less energy connection and a wired energy connection.

9. The connectivity platform as claimed in claim 6, wherein the communication port comprises at least one of a wireless communication port and a wired communication port.

10. The connectivity platform as claimed in claim 6, wherein the processing unit further provides a disabling signal to the processing device for disabling the given existing peripheral device.

11. A method for optimizing a use of a processing device, the method comprising:
detecting a peripheral device connected to a connectivity platform;
detecting an existing peripheral device used by the processing device;
detecting the processing device wirelessly capable of communicating with the connectivity platform according to a wireless protocol; and
providing an alternate data path for replacing the existing peripheral device with the peripheral device connected to the connectivity platform, the processing device being capable of using the peripheral device connected to the connectivity platform via the alternate path.

12. The method as claimed in claim 11, further comprising providing an energy signal to the detected peripheral device connected to the connectivity platform.

13. The method as claimed in claim 12, wherein the step of providing an energy signal comprises at least one of providing a contact-less energy signal and providing a hardwired energy signal to the detected peripheral device connected to the connectivity platform.

14. The method as claimed in claim 11, wherein the step of providing an alternate data path comprises identifying at least one possible rerouting of data between the processing device and the connectivity platform.

15. The method as claimed in claim 14, further comprising displaying the at least one possible rerouting of data to a user of the processing device.

16. A connectivity platform for optimizing a use of a plurality of peripheral devices with a processing device to which is connected a plurality of existing peripheral devices, the connectivity platform comprising:
a communication port for communicating with the plurality of peripheral devices and further with the processing device;
a memory unit storing an indication of the plurality of peripheral devices and the plurality of existing peripheral devices;
a processing unit operatively coupled to the communication port and the memory unit, the processing unit receiving a data signal provided by the processing device via the communication port and providing at least one part of the data signal to a peripheral device corresponding to a given existing peripheral device via the communication port.

17. The connectivity platform as claimed in claim 16, further comprising an energy connection port, controlled by the processing unit, for providing an energy signal to at least one of the plurality of peripheral devices.

18. The connectivity platform as claimed in claim 17, wherein the energy connection port comprises at least one of a contact-less energy connection and a wired energy connection.

19. The connectivity platform as claimed in claim 16, wherein the communication port comprises at least one of a wireless communication port and a wired communication port.

20. The connectivity platform as claimed in claim 16, wherein the processing unit further provides a disabling signal to the processing device for disabling the given existing peripheral device.
